(19) United States
(12) Patent Application Publication
(10) Pub. No.: US 2026/0253546 A1
(43) Pub. Date: Aug. 27, 2026

(54) PIXEL CIRCUIT AND DISPLAY DEVICE INCLUDING THE SAME

(71) Applicant: LG Display Co., Ltd., Seoul (KR)

(72) Inventor: Dong Hyun LEE, Paju-si (KR)

(73) Assignee: LG Display Co., Ltd., Seoul (KR)

(21) Appl. No.: 19/438,135

(22) Filed: Dec. 31, 2025

(30) Foreign Application Priority Data
Dec. 31, 2024 (KR) 10-2024-0202682

(51) Int. Cl. G09G 3/3233; G09G 3/3266

(52) U.S. Cl. CPC G09G 3/3233; G09G 3/3266; G09G 2300/0819; G09G 2300/0852; G09G 2310/0286; G09G 2310/08; G09G 2330/021; G09G 2340/0435

(57) ABSTRACT

A pixel circuit and a display device including the same are discussed. The pixel circuit can include a driving element, a first switching element configured to be turned on in response to a first scan signal to connect a data voltage line and a third node, a second switching element configured to be turned on in response to a second scan signal to connect the third node and a first node, a third switching element configured to be turned on in response to the second scan signal to connect a reference voltage line and a fourth node, a fourth switching element configured to be turned on in response to the second scan signal to connect the fourth node and the first node, and a first capacitor connected between the third node and the fourth node.

### CROSS-REFERENCE TO RELATED APPLICATION

This application claims priority to and the benefit of Korean Patent Application No. 10-2024-0202682, filed in the Republic of Korea on Dec. 31, 2024, the disclosure of which is hereby expressly incorporated by reference in its entirety.

### BACKGROUND

### Field

Embodiments of the present disclosure relate to a pixel circuit and a display device including the same.

### Discussion of the Related Art

Electroluminescence displays can be classified into inorganic electroluminescence displays and organic electroluminescence displays depending on the material of their light emission layers. Active matrix type organic electroluminescence displays include self-emissive organic light-emitting diodes (hereinafter referred to as “OLEDs”), and have advantages such as fast response speeds, high luminous efficiency, high luminance, and wide viewing angles. In organic electroluminescence displays, OLEDs are formed in respective pixels. The organic electroluminescence displays not only exhibit fast response speeds, high luminous efficiency, high luminance, and wide viewing angles, but also can represent black gradations as a perfect black, thereby providing excellent contrast ratios and color reproducibility.

A pixel circuit is disposed in each pixel of a display device to sense and compensate for the threshold voltage of a driving transistor. In a pixel circuit with a source follower structure, two capacitors are connected between the gate node and the source node of a driving transistor, and the data transfer rate is determined by their sizes. Therefore, there is a problem in that the data transfer loss occurs.

### SUMMARY OF THE DISCLOSURE

An embodiment of the present disclosure provides a pixel circuit that improves data transfer loss caused by capacitors and a display device including the same.

Problems to be solved by the present disclosure are not limited to the above-mentioned problems, and other problems not mentioned can be clearly understood by those skilled in the art from the description of the invention described below.

According to an aspect of the present disclosure, a pixel circuit can include a driving element including a first electrode to which a pixel driving voltage is applied, a gate electrode connected to a first node, and a second electrode connected to a second node; a first switching element configured to be turned on in response to a first scan signal to connect a data voltage line and a third node; a second switching element configured to be turned on in response to a second scan signal to connect the third node and the first node; a third switching element configured to be turned on in response to the second scan signal to connect a reference voltage line and a fourth node; a fourth switching element configured to be turned on in response to the second scan signal to connect the fourth node and the first node; a first capacitor connected between the third node and the fourth node; and a second capacitor connected between the fourth node and the second node.

According to aspects of the present disclosure, the pixel circuit can further include a light-emitting element including an anode electrode connected to a fifth node and a cathode electrode to which a low potential power supply voltage is applied; a fifth switching element configured to be turned on in response to an EM signal to connect the second node and the fifth node; and a sixth switching element configured to be turned on in response to a third scan signal to connect the fifth node and a reset voltage line.

According to aspects of the present disclosure, the first switching element and the third to sixth switching elements can be n-type oxide transistors, and the second switching element and the driving element can be p-type polysilicon transistors.

According to aspects of the present disclosure, the first to sixth switching elements can all be n-type oxide transistors.

According to aspects of the present disclosure, the data voltage supplied to the data voltage line can be higher than the reference voltage supplied to the reference voltage line, and the reference voltage can be higher than the reset voltage supplied to the reset voltage line.

According to aspects of the present disclosure, the pixel circuit can be driven in the order of an initialization stage, a sensing stage, a data writing stage, and a light emission stage, and in the initialization stage, the first switching element and the third to sixth switching elements can be configured to be turned on, and the second switching element can be configured to be turned off, in the sensing stage, the third switching element, the fourth switching element, and the sixth switching element can be configured to be turned on, and the remaining switching elements can be configured to be turned off, in the data writing stage, the second switching element and the sixth switching element can be configured to be turned on, and the remaining switching elements can be configured to be turned off, and in the light emission stage, the second switching element and the fifth switching element can be configured to be turned on, and the remaining switching elements can be configured to be turned off.

According to aspects of the present disclosure, in the initialization stage, the voltages of the first scan signal, the second scan signal, the third scan signal, and the EM signal can all be gate high voltages. In the sensing stage, the voltages of the first scan signal and the EM signal can be gate low voltages, and the voltages of the second scan signal and the third scan signal can be gate high voltages. In the data writing stage, the voltages of the first scan signal, the second scan signal, and the EM signal can be gate low voltages, and the voltage of the third scan signal can be a gate high voltage. In the light emission stage, the voltages of the first to third scan signals can be gate low voltages, and the voltage of the EM signal can be a gate high voltage.

According to aspects of the present disclosure, in the initialization stage, the first switching element can be configured to be turned on to allow the data voltage to be stored in the first capacitor.

According to aspects of the present disclosure, in the initialization stage, a reset voltage can be applied to the fifth node to reset the anode electrode of the light-emitting element.

According to aspects of the present disclosure, in the sensing stage, the threshold voltage of the driving element can be stored in the second capacitor.

According to aspects of the present disclosure, in the data writing stage, the second switching element can be configured to be turned on to allow the data voltage stored in the third node to be charged to the first node.

According to aspects of the present disclosure, in the light emission stage, the third switching element can be configured to be turned off to allow the first capacitor and the second capacitor to be connected in series.

According to an embodiment of the present disclosure, since the transfer rate of the data voltage is not determined by the capacitance ratio of the first capacitor and the second capacitor, but rather the data voltage stored in the first capacitor is applied to the gate electrode of the driving transistor, the transfer rate of the data voltage can be improved to reduce the range of the data voltage. Accordingly, the power consumption of the display device is reduced, enabling low-power driving.

In addition, according to aspects of the present disclosure, during an anode reset frame driving, the threshold voltage can be sensed and compensated during the anode reset interval. Accordingly, accurate sensing of the threshold voltage is possible, thereby improving luminance uniformity.

However, the effects of the present disclosure are not limited to the above-mentioned effects, and other effects not mentioned will be clearly understood by those skilled in the art from the description of the invention described below.

### BRIEF DESCRIPTION OF THE DRAWINGS

Various aspects of the disclosure will become apparent and more readily appreciated from the following description of the embodiments of the present disclosure, taken in conjunction with the accompanying drawings of which:

FIG. 1 is a block diagram showing a display device according to one embodiment of the present disclosure;

FIG. 2 is a cross-sectional view showing a cross-sectional structure of a display panel shown in FIG. 1;

FIG. 3 is a diagram showing a pixel circuit according to one embodiment of the present disclosure;

FIG. 4 is a waveform diagram of the pixel circuit according to one embodiment of the present disclosure;

FIGS. 5A to 5D are circuit diagrams sequentially showing operations of the pixel circuit according to one embodiment of the present disclosure;

FIG. 6 is a diagram showing a pixel circuit according to another embodiment of the present disclosure;

FIG. 7 is a block diagram of a gate driver according to one embodiment of the present disclosure;

FIG. 8 shows a light emission control signal driver according to an embodiment of the present disclosure;

FIG. 9 is a waveform diagram showing a refresh frame and an anode reset frame operation of the pixel circuit in FIG. 5;

FIG. 10 is a circuit diagram showing an initialization stage of the pixel circuit according to one embodiment of the present disclosure; and

FIG. 11 is a circuit diagram showing a threshold voltage sensing stage of the pixel circuit according to one embodiment of the present disclosure.

### DETAILED DESCRIPTION OF THE EMBODIMENTS

The advantages and features of the present disclosure, and methods of achieving them will be apparent from the embodiments of the present disclosure described in detail below in conjunction with the accompanying drawings. The present invention is not limited to the following embodiments, which can be implemented in various different forms; rather, the present embodiments are provided to make the disclosure of the present invention complete and to allow those skilled in the art to fully understand the scope of the present invention, and the present invention is defined only within the scope of the appended claims.

The shapes, sizes, proportions, angles, numbers and the like shown in the accompanying drawings for the purpose of describing the embodiments of the present disclosure are merely examples, and the present disclosure is not limited thereto. Like reference numerals generally denote like elements throughout the present specification. Further, in describing the present disclosure, detailed descriptions of known related technologies can be omitted so as not to unnecessarily obscure the subject matter of the present disclosure.

The terms such as “comprising,” “including,” “having,” and “consisting of” used herein are generally intended to allow other components to be added unless the terms are used with the term “only.” References to the singular shall be construed to include the plural unless expressly stated otherwise. Further, the term “can” fully encompasses all the meanings and coverages of the term “may” and vice versa.

In the interpretation of components, they are construed to include margins of error, even if not explicitly stated.

When describing a positional relationship, for example, “on,” “above,” “below,” or “next to” describes the positional relationship between two components, one or more other components can be interposed between the two components, unless “immediately” or “directly” is used.

The terms such as first, second, and so on can be used to distinguish the components, but the functions or structures of these components are not limited to the ordinal number or component name attached to the component.

The following embodiments of the present disclosure can be combined or associated with each other in whole or in part, and various types of interlocking and driving are technically possible. The embodiments of the present disclosure can be implemented independently of one another or can be implemented together in an interrelated relationship.

Each of pixels is divided into a plurality of sub-pixels having different colors to implement color, and each of the sub-pixels includes a transistor used as a switch element or a driving element. Such a transistor can be implemented as a thin film transistor (TFT).

A driving circuit of a display device writes pixel data of an input image to the pixels. A driving circuit of a flat panel display device includes a data driver for supplying a data signal to data lines, a gate driver for supplying a gate signal to gate lines, and the like.

In the display device of the present disclosure, the pixel circuit can include a plurality of transistors. The transistors can be implemented as an oxide thin film transistor (TFT) including an oxide semiconductor or a low temperature poly silicon TFT (LTPS TFT) including a low temperature poly silicon.

A transistor is a three-electrode element including a gate, a source, and a drain. The source is an electrode that supplies carriers to the transistor. In the transistor, the carriers start to flow from the source. The drain is an electrode through which the carriers exit to outside from the transistor. In the transistor, the carriers flow from the source to the drain. In the case of an n-channel transistor, since the carriers are electrons, a source voltage is lower than a drain voltage, allowing the electrons to flow from the source to the drain. In the n-channel transistor, the direction of current is from the drain to the source. In the case of a p-channel transistor, since the carriers are holes, a source voltage is higher than a drain voltage such that the holes can flow from the source to the drain. In the p-channel transistor, the current flows from the source to the drain because the holes flow from the source to the drain. It should be noted that the source and the drain of the transistor are not fixed. For example, the source and the drain can be changed according to an applied voltage. Therefore, the present disclosure is not limited by the source and the drain of the transistor. In the following description, the source and the drain of a transistor will be referred to as a first electrode and a second electrode.

A gate signal can swing between a gate-on voltage and a gate-off voltage. The gate-on voltage is set to a voltage higher than the threshold voltage of the transistor. The gate-off voltage is set to a voltage lower than the threshold voltage of the transistor.

The transistor is turned on in response to the gate-on voltage and is turned off in response to the gate-off voltage. In the case of the n-channel transistor, the gate-on voltage can be gate high voltages VGH and VEH, and the gate-off voltage can be gate low voltages VGL and VEL.

Hereinafter, various embodiments of the present disclosure will be described in detail with reference to the accompanying drawings. In the following embodiments of the present disclosure, a display device will be described focusing on an organic light-emitting display device, but the present disclosure is not limited thereto. All the components of each display device/apparatus according to all embodiments of the present disclosure are operatively coupled and configured. The present disclosure is not intended to be limited by the names of components or signals in the description of the embodiments of the present disclosure.

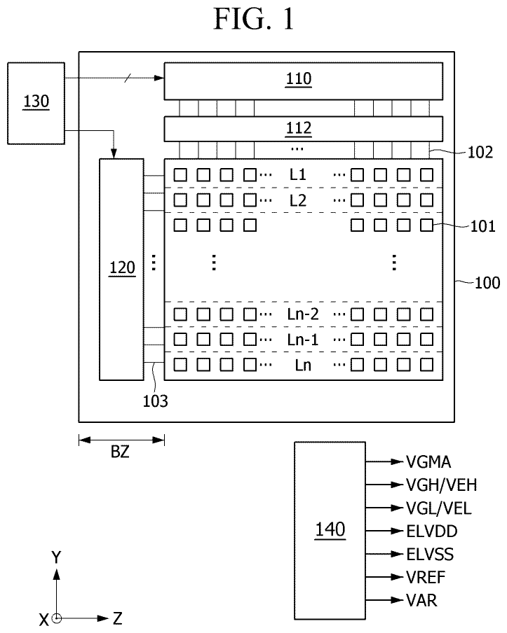

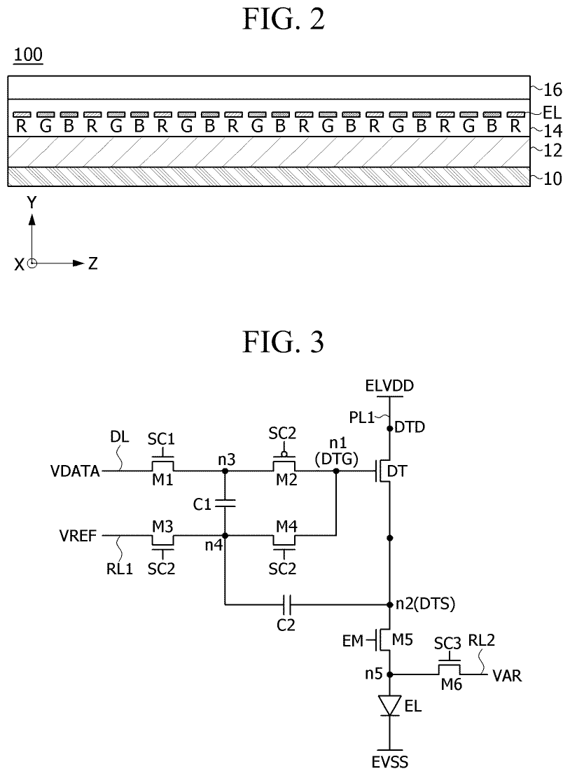

FIG. 1 is a block diagram showing a display device according to one embodiment of the present disclosure. FIG. 2 is a cross-sectional view showing a cross-sectional structure of a display panel shown in FIG. 1.

Referring to FIGS. 1 and 2, a display device according to an embodiment of the present disclosure includes a display panel 100, a display panel driver for writing pixel data into the pixels of the display panel 100, and a power supply 140 generating power required for driving the pixels and the display panel driver.

The display panel 100 can be a rectangular structure having a length in an X-axis direction, a width in a Y-axis direction, and a thickness in a Z-axis direction. The display panel 100 can include a pixel array for displaying an input image on a screen. The pixel array includes a plurality of data lines 102, a plurality of gate lines 103 crossing the data lines 102, and pixels disposed in a matrix form. The display panel 100 can further include power lines commonly connected to the pixels. The power lines can include a power line to which a pixel driving voltage ELVDD is applied, a power line to which a reference voltage VREF is applied, and a power line to which a low potential power supply voltage ELVSS is applied. Such power lines are commonly connected to the pixels.

The pixel array includes a plurality of pixel lines L1 to Ln. Each of the pixel lines L1 to Ln includes one line of pixels disposed along a line direction (X direction) in the pixel array of the display panel 100. The pixels disposed in one pixel line share the gate lines 103. Sub-pixels disposed in a column direction (Y direction) along the data line direction share the same data line 102. One horizontal period (1H) is a time obtained by dividing one frame period by the total number of pixel lines L1 to Ln.

The display panel 100 can be implemented as a non-transparent display panel or a transmissive display panel. A transmissive display panel can be applied to a transparent display device in which an image is displayed on the screen and an actual object in the background can be seen.

The display panel can be fabricated as a flexible display panel. The flexible display panel can be implemented as an OLED panel using a plastic substrate. A pixel array and a light-emitting element of the plastic OLED panel can be disposed on an organic thin-film layer adhered onto a back plate.

Each of the pixels 101 can be divided into a red sub-pixel, a green sub-pixel, and a blue sub-pixel for color realization. Each of the pixels can further include a white sub-pixel. Each of the sub-pixels includes a pixel circuit. Hereinafter, the term “pixel” can be interpreted to mean a sub-pixel. Each pixel circuit is connected to the data lines, the gate lines, and the power lines.

The pixels can be disposed as real-color pixels or pentile pixels. The pentile pixel can realize a higher resolution than a real-color pixel by driving two sub-pixels of different colors as one pixel 101 using a preset pixel rendering algorithm. The pixel rendering algorithm can compensate for insufficient color representation in each pixel by the color of light emitted from adjacent pixels.

Touch sensors can be disposed on the screen of the display panel 100. The touch sensors can be implemented as on-cell type or add-on type touch sensors disposed on the screen of the display panel, or as in-cell type touch sensors embedded in the pixel array AA.

The display panel 100, when viewed in cross-section, can include a circuit layer 12, a light-emitting element layer 14, and an encapsulation layer 16 stacked on a substrate 10, as shown in FIG. 2.

The circuit layer 12 can include pixel circuits connected to wires such as data lines, gate lines, and power lines, a gate driver (GIP) connected to the gate lines, a demultiplexer array 112, and a circuit for auto probe inspection, which is omitted in the drawings. The wires and circuit elements of the circuit layer 12 can include a plurality of insulating layers, two or more metal layers separated by the insulating layers, and an active layer including a semiconductor material.

The light-emitting element layer 14 can include a light-emitting element EL driven by the pixel circuit. The light-emitting element EL can include a red R light-emitting element, a green G light-emitting element, and a blue B light-emitting element. The light-emitting element layer 14 can include a white light-emitting element and a color filter. The light-emitting element EL of the light-emitting element layer 14 can be covered by a multi-protection layer including an organic film and an inorganic film.

The encapsulation layer 16 covers the light-emitting element layer 14 to seal the circuit layer 12 and the light-emitting element layer 14. The encapsulation layer 16 can be a multi-insulating film structure in which an organic film and an inorganic film are alternately stacked. The inorganic film blocks penetration of moisture or oxygen. The organic film planarizes the surface of the inorganic film. If the organic film and the inorganic film are stacked in multiple layers, penetration of moisture or oxygen affecting the light-emitting element layer 14 can be effectively blocked because a movement path of moisture or oxygen becomes longer compared with a single layer.

A touch sensor layer formed on the encapsulation layer 16 can be disposed. The touch sensor layer can include capacitive touch sensors that sense a touch input based on a change in capacitance before and after the touch input. The touch sensor layer can include metal wire patterns forming capacitance of the touch sensors and insulating films. Capacitance of the touch sensors can be formed between the metal wire patterns. A polarizing plate can be disposed on the touch sensor layer. The polarizing plate converts polarization of external light reflected by the metal of the touch sensor layer and the circuit layer 12 to improve visibility and contrast ratio. The polarizing plate can be implemented as a polarizing plate in which a linear polarizing plate and a phase retardation film are bonded, or as a circular polarizing plate. A cover glass can be attached on the polarizing plate.

The display panel 100 can further include a touch sensor layer stacked on the encapsulation layer 16 and the color filter layer. The color filter layer can include red, green, and blue color filters and a black matrix pattern. The color filter layer can absorb a part of wavelengths of light reflected from the circuit layer and the touch sensor layer to substitute for the role of the polarizing plate and to enhance color purity. This embodiment can apply a color filter layer 20 with high light transmittance compared to a polarizing plate to the display panel in order to improve the light transmittance of the display panel PNL and to improve the thickness and flexibility of the display panel PNL. The cover glass can be attached on the color filter layer.

The power supply 140 generates direct current (DC) power required for driving the pixel array of the display panel 100 and the display panel driver by using a DC-DC converter. The DC-DC converter can include a charge pump, a regulator, a buck converter, a boost converter, and the like. The power supply 140 can generate constant voltages (or DC voltages) such as a gamma reference voltage VGMA, gate-on voltages VGH and VEH, gate-off voltages VGL and VEL, a pixel driving voltage ELVDD, a low potential power supply voltage ELVSS, a reference voltage VREF, and an anode reset voltage VAR by adjusting a level of a DC input voltage applied from a host system. The gamma reference voltage VGMA can be supplied to a data driver 110. The gate-on voltages VGH and VEH and the gate-off voltages VGL and VEL are supplied to a gate driver 120. The constant voltages such as the pixel driving voltage ELVDD, the low potential power supply voltage ELVSS, the reference voltage VREF, and the anode reset voltage VAR are commonly supplied to the pixels.

The display panel driver writes pixel data of input images into the pixels of the display panel 100 under control of a timing controller 130.

The display panel driver includes the data driver 110 and the gate driver 120. The display panel driver can further include a demultiplexer array 112 disposed between the data driver 110 and the data lines 102.

The demultiplexer array 112 sequentially supplies data voltages output from respective channels of the data driver 110 to the data lines 102 by using a plurality of demultiplexers (DEMUX). The demultiplexer can include a plurality of switching elements disposed on the display panel 100. If the demultiplexer is disposed between the output terminals of the data driver 110 and the data lines 102, the number of channels of the data driver 110 can be reduced. The demultiplexer array 112 can be omitted.

The display panel driver can further include a touch sensor driver for driving the touch sensors. The touch sensor driver is omitted in FIG. 1. The data driver and the touch sensor driver can be integrated into one drive integrated circuit (IC). In a mobile device or a wearable device, the timing controller 130, the power supply 140, the data driver 110, and the touch sensor driver can be integrated into one drive IC.

The display panel driver can operate in a low speed driving mode under control of the timing controller 130. The low speed driving mode can be set to reduce power consumption of the display device when the input image has no change for a preset time by analyzing the input image. The low speed driving mode can reduce power consumption of the display panel driver and the display panel 100 by lowering a refresh rate of the pixels when a still image is input for a predetermined time or longer. The low speed driving mode is not limited to only when a still image is input for a predetermined time or longer. For example, when the display device operates in a standby mode, or when a user command or an input image is not input to the display panel driving circuit for a predetermined time or longer, the display panel driving circuit can operate in the low speed driving mode.

The data driver 110 generates a data voltage by converting pixel data of an input image, which is received as a digital signal from the timing controller 130 every frame period, into a gamma compensated voltage using a digital to analog converter (DAC). The gamma reference voltage VGMA is divided into gamma compensated voltages for each grayscale through a voltage divider circuit and is supplied to the DAC. The data voltage is output through an output buffer from respective channels of the data driver 110.

The gate driver 120 can be implemented as a gate in panel (GIP) circuit directly formed in the circuit layer 12 of the display panel 100 together with a TFT array and wires of the pixel array. The GIP circuit can be disposed on a bezel area BZ, which is a non-display area of the display panel 100, or can be distributed and disposed in the pixel array in which an input image is reproduced. The gate driver 120 sequentially outputs gate signals to the gate lines 103 under control of the timing controller 130. The gate driver 120 can sequentially supply the gate signals to the gate lines 103 by shifting the gate signals using a shift register. The gate signals can include a scan signal and a light emission control signal (hereinafter referred to as an EM signal).

The shift register of the gate driver 120 outputs a pulse of a gate signal in response to a start pulse and a shift clock from the timing controller 130, and shifts the pulse in synchronization with the shift clock timing.

The timing controller 130 receives digital video data DATA of an input image and a timing signal synchronized with the digital video data from a host system. The timing signal can include a vertical synchronization signal Vsync, a horizontal synchronization signal Hsync, a clock CLK, a data enable signal DE, and the like. Since vertical and horizontal periods can be known by counting the data enable signal DE, the vertical synchronization signal Vsync and the horizontal synchronization signal Hsync can be omitted. The data enable signal DE has a period of one horizontal period 1H.

The host system can be any one of a television (TV) system, a tablet computer, a notebook computer, a navigation system, a personal computer (PC), a home theater system, a mobile device, a wearable device, and a vehicle system. The host system can scale a video signal from a video source to match the resolution of the display panel 100 and transmit the video signal together with a timing signal to the timing controller 130.

The timing controller 130 can multiply the input frame frequency by i (where i is a natural number) in a normal driving mode to control the operation timing of the display panel driver at a frame frequency of input frame frequency×i Hz. The input frame frequency is 60 Hz in the national television standards committee (NTSC) format and 50 Hz in the phase-alternating line (PAL) format. The timing controller 130 can lower the frame frequency of the display panel driver to a frequency between 1 Hz and 30 Hz in a low-speed driving mode to reduce the refresh rate of the pixels.

The timing controller 130 generates a data timing control signal for controlling an operation timing of the data driver 110, a control signal for controlling an operation timing of the demultiplexer array 112, and a gate timing control signal for controlling an operation timing of the gate driver 120, based on the timing signals Vsync, Hsync, and DE received from the host system. The timing controller 130 controls the operation timing of the display panel driver to synchronize the data driver 110, the demultiplexer array 112, the touch sensor driver, and the gate driver 120.

The voltage level of the gate timing control signal output from the timing controller 130 can be converted into the gate-on voltages VGH and VEH and the gate-off voltages VGL and VEL through a level shifter and supplied to the gate driver 120. The level shifter can convert a low-level voltage of the gate timing control signal into the gate-on voltage VGH and VEH, and can convert a high-level voltage of the gate timing control signal into the gate-off voltage VGL and VEL. The gate timing signal can include a start pulse and a shift clock.

Due to process deviations and element characteristic deviations in the manufacturing process of the display panel 100, there can be differences in the electrical characteristics of the driving elements among the pixels, and these differences can increase as driving time of the pixels elapses. In order to compensate for deviations in the electrical characteristics of the driving elements among the pixels, an internal compensation technique or an external compensation technique can be applied to the organic electroluminescence display. The internal compensation technique uses an internal compensation circuit implemented in each pixel circuit to sample the threshold voltage of the driving element for each sub-pixel and compensate for the gate-source voltage Vgs of the driving element by the amount of the threshold voltage. The external compensation technique uses an external compensation circuit to sense in real time the current or voltage of the driving element that changes according to the electrical characteristics of the driving element. The external compensation technique compensates in real time for deviations (or changes) in the electrical characteristics of the driving element for each pixel by modulating pixel data (digital data) of the input image by the amount of the sensed deviation (or change) in the electrical characteristics of the driving element for each pixel. The display panel driver can use the external compensation technique and/or the internal compensation technique to drive the pixels.

FIG. 3 is a diagram showing a pixel circuit according to one embodiment of the present disclosure.

Referring to FIG. 3, the pixel circuit according to the embodiment includes a light-emitting element EL, a driving element DT for driving the light-emitting element EL, a plurality of switching elements M1 to M6, and capacitors C1 and C2. The driving element DT and the plurality of switching elements M1 to M6 can be implemented as thin film transistors. The first switching element M1, and the third to sixth switching elements M3, M4, M5, and M6 can be n-type oxide transistors. The second switching transistor can be a p-type low temperature polycrystalline silicon (LTPS) transistor. In the pixel circuit, some of the switching elements can be fabricated with oxide thin film transistors having excellent insulation performance, while some of the switching elements can be composed of polysilicon transistors for fast response characteristics.

The driving element DT generates a current for driving the light-emitting element EL according to a gate-source voltage Vgs. The driving element DT includes a gate electrode DTG connected to a first node n1, a first electrode DTD connected to a pixel driving voltage, and a second electrode DTS connected to a second node n2.

The light-emitting element EL can be implemented as an OLED or an inorganic LED. The OLED includes an anode electrode, a cathode electrode, and an organic compound layer interposed between the electrodes. The anode electrode of the light-emitting element EL is electrically connected to a fifth node n5, and the cathode electrode is supplied with a cathode voltage ELVSS.

The organic compound layer can include, but is not limited to, a hole injection layer HIL, a hole transport layer HTL, a light emission layer EML, an electron transport layer ETL, and an electron injection layer EIL. If a voltage is applied to the anode electrode and the cathode electrode of the light-emitting element EL, holes passing through the hole transport layer HTL and electrons passing through the electron transport layer ETL migrate to the light emission layer EML to form excitons. In this case, visible light is emitted from the light emission layer EML. The OLED can be implemented as a tandem structure OLED in which a plurality of light emission layers are stacked. The OLED of the tandem structure can improve pixel luminance and lifetime.

The first switching element M1 has a first electrode connected to a data voltage line DL to which a data voltage VDATA is applied and a second electrode connected to a third node n3. A gate electrode of the first switching element M1 can be connected to a first scan line. The gate electrode of the first switching element M1 can be turned on in response to the gate high voltages VGH and VEH of a first scan signal SC1 and turned off in response to the gate low voltages VGL and VEL. If the first switching element M1 is turned on, the data voltage VDATA can be applied to the third node n3.

The second switching element M2 has a first electrode connected to the third node n3 and a second electrode connected to the first node n1. A gate electrode of the second switching element M2 can be connected to the second scan line. Since the second switching element M2 is a p-type transistor, it can be turned on in response to the gate low voltages VGL and VEL of a second scan signal SC2 and turned off in response to the gate high voltages VGH and VEH. If the second switching element M2 is turned on, a voltage of the second node n2 can be applied to the first node n1.

The third switching element M3 has a first electrode connected to a reference voltage line RL1 and a second electrode connected to a fourth node n4. A gate electrode of the third switching element M3 can be connected to the second scan line. Since the third switching element M3 is an n-type thin film transistor, it can be turned on in response to the gate high voltages VGH and VEH of the second scan signal SC2 and turned off in response to the gate low voltages VGL and VEL. If the third switching element M3 is turned on, the reference voltage VREF can be applied to the fourth node n4.

The fourth switching element M4 has a first electrode connected to the fourth node n4 and a second electrode connected to the first node n1. A gate electrode of the fourth switching element M4 can be connected to the second scan line. Since the fourth switching element M4 is an n-type thin film transistor, it can be turned on in response to the gate high voltages VGH and VEH of the second scan signal SC2 and turned off in response to the gate low voltages VGL and VEL. If the fourth switching element M4 is turned on, the voltage of the fourth node n4 can be applied to the first node n1.

The fifth switching element M5 has a first electrode connected to the second node n2 and a second electrode connected to the fifth node n5. A gate electrode of the fifth switching element M5 can be connected to an EM line. Since the fifth switching element M5 is an n-type thin film transistor, it can be turned on in response to the gate high voltages VGH and VEH of the EM signal EM and turned off in response to the gate low voltages VGL and VEL.

The sixth switching element M6 has a first electrode connected to a reset voltage line RL2 and a second electrode connected to the fifth node n5. A gate electrode of the sixth switching element M6 can be connected to a third scan line. Since the sixth switching element M6 is an n-type thin film transistor, it can be turned on in response to the gate high voltages VGH and VEH of the third scan signal SC3 and turned off in response to the gate low voltages VGL and VEL. If the sixth switching element M6 is turned on, a reset voltage can be applied to the anode electrode of the light-emitting element EL.

The first capacitor C1 and the second capacitor C2 can maintain the gate-source voltage Vgs of the driving element DT constant during one frame. The first capacitor C1 can store the data voltage VDATA, and the second capacitor C2 can store a threshold voltage Vth of the driving element DT.

The first terminal of the first capacitor C1 is connected to the third node n3, and the second terminal is connected to the fourth node n4. The first terminal of the first capacitor C1 can be connected to the second electrode of the first switching element M1 and the first electrode of the second switching element M2. The second terminal of the first capacitor C1 can be connected to the second electrode of the third switching element M3, the first electrode of the fourth switching element M4, and the first terminal of the second capacitor C2.

The first terminal of the second capacitor C2 is connected to the fourth node n4, and the second terminal is connected to the second node n2. The first terminal of the second capacitor C2 can be connected to the second electrode of the third switching element M3, the first electrode of the fourth switching element M4, and the second terminal of the first capacitor C1. The second terminal of the second capacitor C2 can be connected to the second node n2.

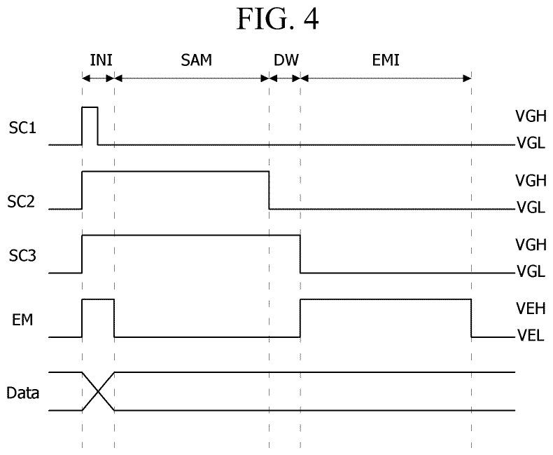

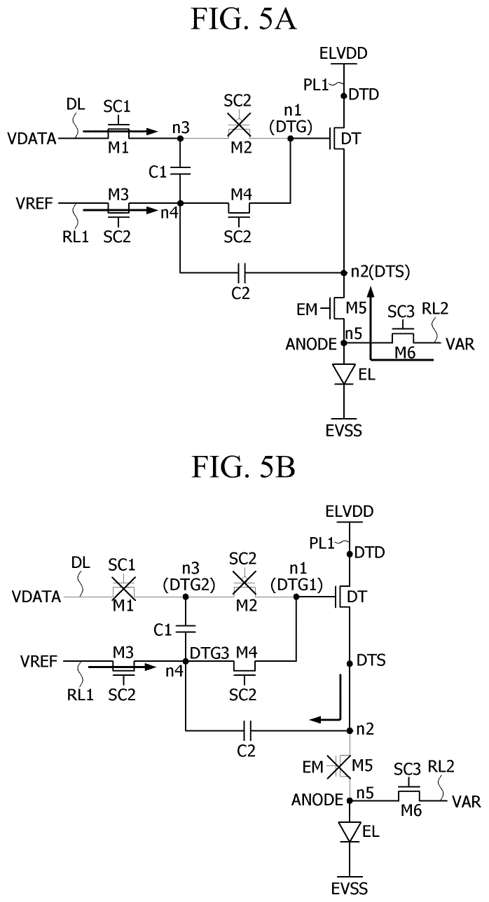

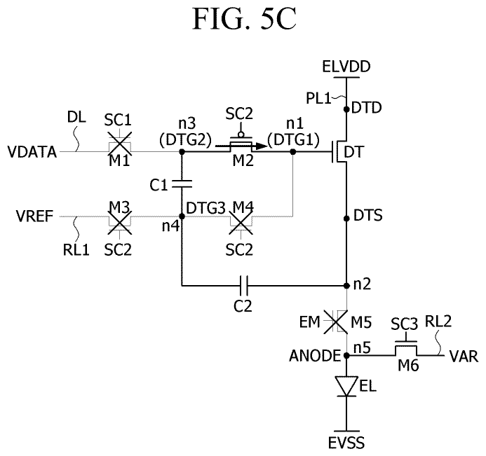

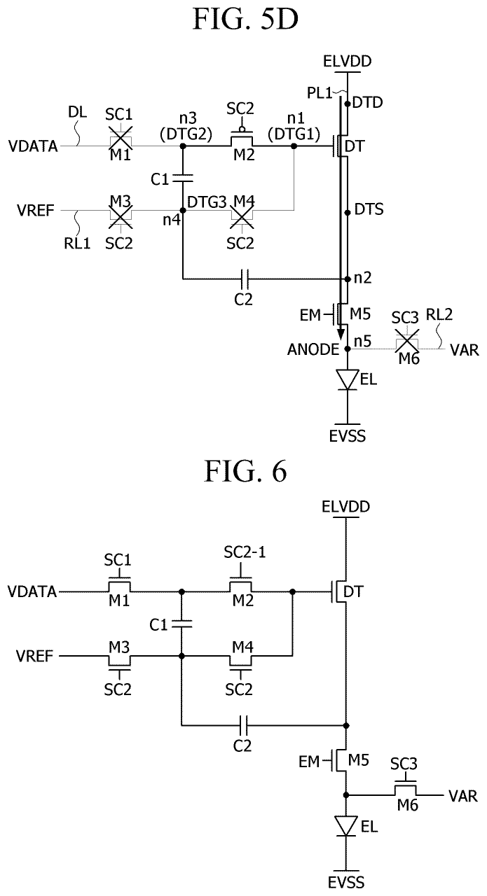

FIG. 4 is an operation waveform diagram of the pixel circuit according to one embodiment of the present disclosure. FIGS. 5A to 5D are circuit diagrams sequentially showing operations of the pixel circuit according to one embodiment of the present disclosure.

A refresh frame can include an initialization stage INI, a sampling stage SAM, a data writing stage DW, and a light emission stage EMI. The initialization stage INI is a period for initializing the capacitors and the gate electrode of the driving element DT, the sampling stage SAM is a period for sensing the threshold voltage of the driving element DT, the data writing stage DW is a period for storing the data voltage VDATA, and the light emission stage EMI is a period in which the light-emitting element EL is turned on.

Referring to FIG. 5A, in the initialization stage INI, the first scan signal SC1, the second scan signal SC2, the third scan signal SC3, and the EM signal EM can all be applied with the gate high voltages VGH and VEH. Accordingly, the first switching element M1 and the third to sixth switching elements M3, M4, M5, and M6 can be turned on, and the second switching element M2 can be turned off.

Since the first switching element M1 is turned on, the data voltage VDATA can be charged to the third node n3. Since the third switching element M3 is turned on, the reference voltage VREF can be applied to the fourth node n4. Since the first capacitor C1 is connected between the second node n2 and the fourth node n4, the first capacitor C1 can be initialized with a voltage of VDATA-VREF. The data voltage VDATA can be higher than the reference voltage VREF.

Since the fifth switching element M5 and the sixth switching element M6 are turned on in the initialization stage INI, a reset voltage can be applied to the second node n2 and the fifth node n5. Since the reset voltage is sufficiently low, the light-emitting element EL may not emit light during the initialization stage INI.

Since the second capacitor C2 is connected between the second node n2 and the fourth node n4, the second capacitor C2 can be initialized with a voltage of VREF-VAR.

According to the embodiment, since the reference voltage VREF is applied to the fourth node n4, which is between the first capacitor C1 and the second capacitor C2, the data voltage VDATA of the third node n3 may not be distributed by the first capacitor C1 and the second capacitor C2. Accordingly, the data voltage VDATA can be completely stored in the first capacitor C1. Therefore, in the initialization stage INI, data can be stored in the first capacitor C1.

Referring to FIG. 5B, in the sampling stage SAM, the first scan signal SC1 and the EM signal EM can be applied with the gate low voltages VGL and VEL, and the second scan signal SC2 and the third scan signal SC3 can maintain the gate high voltages VGH and VEH. Accordingly, the third switching element M3, the fourth switching element M4, and the sixth switching element M6 can remain turned on, and the first switching element M1, the second switching element M2, and the fifth switching element M5 can be turned off.

Since the fifth switching element M5 is turned off and the third and fourth switching elements M3 and M4 remain turned on, a voltage of the second node n2 can increase. As the voltage of the second node n2 increases, when the gate-source voltage Vgs of the driving element DT reaches the threshold voltage Vth, the driving element DT can be turned off, and the threshold voltage Vth can be stored in the second capacitor C2.

Referring to FIG. 5C, in the data writing stage DW, the first scan signal SC1, the second scan signal SC2, and the EM signal EM can be applied with the gate low voltages VGL and VEL, and the third scan signal SC3 can be applied with the gate high voltages VGH and VEH. Accordingly, the second switching element M2 can be turned on, and the sixth switching element M6 can remain turned on. The first switching element M1, the third switching element M3, the fourth switching element M4, and the fifth switching element M5 can be turned off.

Since the second switching element M2 is turned on, the data voltage stored in the second node n2 can be transferred to the first node n1. According to the embodiment, the first capacitor C1 and the second capacitor C2, which are connected to the third node n3 and the second node n2, respectively, can be separated by forming the fourth node n4 between the first capacitor C1 and the second capacitor C2 and applying the reference voltage VREF to the fourth node n4. Accordingly, the data voltage VDATA input to the third node n3 can be input to the first node n1 without loss, as it is not distributed by the first capacitor C1 and the second capacitor C2. Therefore, during data writing, the data voltage VDATA can be applied to the first node n1 without data transfer rate loss.

According to the embodiment, since the transfer rate of the data voltage is not determined by the capacitance ratio of the first capacitor C1 and the second capacitor C2, the date transfer rate can be improved to reduce the range of the data voltage. Accordingly, the power consumption of the display device is reduced, enabling low-power driving.

Referring to FIG. 5D, in the light emission stage EMI, the first to third scan signals SC1 to SC3 can be applied with the gate low voltage VGL and VEL and the EM signal EM can be applied with the gate high voltage VGH and VEH. Accordingly, the second switching element M2 can remain turned on, and the fifth switching element M5 can be turned on. The first switching element M1, the third switching element M3, the fourth switching element M4, and the sixth switching element M6 can be turned off.

According to the embodiment, since the third switching element M3 is turned off, the first capacitor C1 and the second capacitor C2 can be formed in series in the light emission stage EMI. Accordingly, the total capacitance of the first capacitor C1 and the second capacitor C2 can be reduced, and the luminance fluctuation characteristics can be improved. If the first capacitor C1 and the second capacitor C2 are connected in series and thus the total capacitance is reduced, a voltage charging speed of the second node n2 can become faster in the light emission stage. For example, as a potential difference DTS-ELVSS of the light-emitting element is formed in a shorter time, the time required for light emission can become relatively faster. Therefore, when expressing a low grayscale in a short EM duty signal interval, the light emission start time becomes faster and the light emission duration within the same period becomes longer, which can improve the luminance fluctuation characteristics.

In addition, according to the embodiment, since the pixel driving voltage ELVDD is not connected to the capacitor, it is possible to prevent the luminance from being degraded due to ripple. Furthermore, a light emission control switching element disposed between the pixel driving voltage ELVDD and the driving element DT can be omitted.

A current generated by the gate-source voltage Vgs of the driving element DT can be supplied to the light-emitting element EL, allowing the light-emitting element EL to emit light.

In this case, the current IOLED flowing through the light-emitting element EL, the gate-source voltage Vgs of the driving element DT, and the threshold voltage Vth of the driving element DT can satisfy the following Relation 1:

$$IOLED = {k ( Vgs - \vert Vth \vert )}^{2} = {k ( ( DATA - REF + Vth ) - \vert Vth \vert )}^{2} = {k ( DATA - REF )}^{2} \qquad [ Relation 1 ]$$

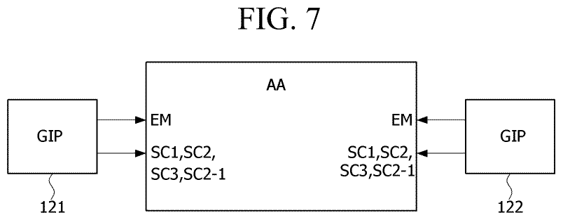

FIG. 6 is a diagram showing a pixel circuit according to another embodiment of the present disclosure.

Referring to FIG. 6, the pixel circuit according to the embodiment includes a light-emitting element EL, a driving element DT for driving the light-emitting element EL, a plurality of switching elements M1 to M6, and capacitors C1 and C2. According to the embodiment, the driving element DT and the first to sixth switching elements M1 to M6 can be n-type oxide transistors.

According to the embodiment, since the switching elements constituting the pixel circuit are all oxide transistors, there is an advantage that an excimer laser annealing process can be performed only in a non-display area NA. If a polycrystalline silicon thin film transistor is present within the display area AA, a laser annealing process should be performed on the entire panel, which presents the problem of increased manufacturing costs and process time. In addition, since the polycrystalline silicon thin film transistor and the oxide thin film transistor are disposed together in the pixel, a problem of increased process complexity is presented.

The driving element DT generates a current for driving the light-emitting element EL according to a gate-source voltage Vgs. The driving element DT includes a gate electrode G connected to the first node n1, a first electrode S connected to the pixel driving voltage, and a second electrode D connected to the second node n2.

The first switching element M1 has a first electrode connected to the data voltage line DL that applies a data voltage, and a second electrode connected to the third node n3. A gate electrode of the first switching element M1 can be connected to the first scan line. The gate electrode of the first switching element M1 can be turned on in response to the gate high voltages VGH and VEH of the first scan signal SC1 and turned off in response to the gate low voltages VGL and VEL. If the first switching element M1 is turned on, the data voltage can be applied to the third node n3.

The second switching element M2 has a first electrode connected to the third node n3 and a second electrode connected to the first node n1. A gate electrode of the second switching element M2 can be connected to a second-first scan line SC2-1. Since the second switching element M2 is a p-type thin film transistor, it can be turned on in response to the gate low voltages VGL and VEL of the second-first scan signal SC2-1 and turned off in response to the gate high voltages VGH and VEH. If the second switching element M2 is turned on, a voltage of the second node n2 can be applied to the first node n1.

The second-first scan signal SC2-1 can have a phase opposite to that of the second scan signal SC2. The second scan signal SC2 and the second-first scan signal SC2-1 can be output from a single gate driver with differently modulated phases. According to this configuration, there is no need to additionally provide a separate gate driver. However, the present embodiment is not limited thereto. For example, a separate gate driver that outputs a fourth scan signal SC4 can additionally be provided.

The third switching element M3 has a first electrode connected to a reference voltage line RL1 and a second electrode connected to a fourth node n4. A gate electrode of the third switching element M3 can be connected to the second scan line. Since the third switching element M3 is an n-type thin film transistor, it can be turned on in response to the gate high voltages VGH and VEH of the second scan signal SC2 and turned off in response to the gate low voltages VGL and VEL. If the third switching element M3 is turned on, the reference voltage can be applied to the fourth node n4.

The fourth switching element M4 has a first electrode connected to the fourth node n4 and a second electrode connected to the first node n1. A gate electrode of the fourth switching element M4 can be connected to the second scan line. Since the fourth switching element M4 is an n-type thin film transistor, it can be turned on in response to the gate high voltages VGH and VEH of the second scan signal SC2 and turned off in response to the gate low voltages VGL and VEL. If the fourth switching element M4 is turned on, the voltage of the fourth node n4 can be applied to the first node n1.

The fifth switching element M5 has a first electrode connected to the second node n2 and a second electrode connected to the fifth node n5. A gate electrode of the fifth switching element M5 can be connected to an EM line. Since the fifth switching element M5 is an n-type thin film transistor, it can be turned on in response to the gate high voltages VGH and VEH of the EM signal EM and turned off in response to the gate low voltages VGL and VEL.

The sixth switching element M6 has a first electrode connected to the reset voltage line RL2 and a second electrode connected to the fifth node n5. A gate electrode of the sixth switching element M6 can be connected to a third scan line. Since the sixth switching element M6 is an n-type thin film transistor, it can be turned on in response to the gate high voltages VGH and VEH of the third scan signal SC3 and turned off in response to the gate low voltages VGL and VEL. If the sixth switching element M6 is turned on, the reset voltage can be applied to the anode electrode of the light-emitting element EL.

The first capacitor C1 and the second capacitor C2 can maintain the gate-source voltage Vgs of the driving element DT constant during one frame. The first capacitor C1 can store the data voltage VDATA, and the second capacitor C2 can store a threshold voltage Vth of the driving element DT.

The first terminal of the first capacitor C1 is connected to the third node n3, and the second terminal is connected to the fourth node n4. The first terminal of the first capacitor C1 can be connected to the second electrode of the first switching element M1 and the first electrode of the second switching element M2. The second terminal of the first capacitor C1 can be connected to the second electrode of the third switching element M3, the first electrode of the fourth switching element M4, and the first terminal of the second capacitor C2.

The first terminal of the second capacitor C2 is connected to the fourth node n4, and the second terminal is connected to the second node n2. The first terminal of the second capacitor C2 can be connected to the second electrode of the third switching element M3, the first electrode of the fourth switching element M4, and the second terminal of the first capacitor C1. The second terminal of the second capacitor C2 can be connected to the second node n2.

According to the embodiment, since the pixel circuit is entirely composed of oxide thin-film transistors, there is an advantage that a separate ELA process can be omitted. Therefore, the ELA process can be simplified by applying it only to the gate driver.

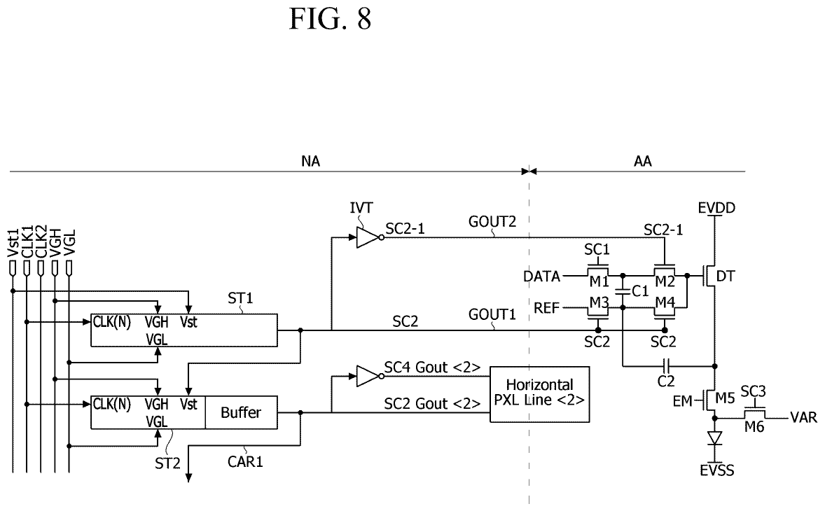

FIG. 7 is a block diagram of a gate driver according to one embodiment of the present disclosure. FIG. 8 shows a light emission control signal driver according to an embodiment of the present disclosure.

Referring to FIG. 7, a first gate driver 121 can be disposed on the left side and a second gate driver 122 can be disposed on the right side with respect to a display area AA.

The first gate driver 121 and the second gate driver 122 can respectively apply the EM signal EM and the first to third scan signals SC1 to SC3 to the pixel circuit of the display panel. If the second switching element M2 is an n-type oxide transistor, the first gate driver and the second gate driver can apply a fourth scan signal SC4 or a second-first scan signal to the second switching transistor.

Referring to FIG. 8, the shift register of the gate driver 120 includes cascaded-connected stages ST. The stages ST1 and ST2 receive a start pulse or a carry signal CAR, and receive clocks VST1, CLK1, and CLK2 through clock lines. The carry signal CAR is output from a previous stage and can be input to a VST node of a next stage.

Each stage sequentially outputs a gate signal and simultaneously outputs a carry signal. Among them, the first stage ST1 that outputs a gate signal to the second switching element M2 can include a first output line GOUT1 for outputting the second scan signal SC2 to the third switching element M3 and the fourth switching element M4, and a second output line GOUT2 for outputting a second-1 scan signal SC2-1 having a phase opposite to that of the second scan signal SC2. The second output line GOUT2 can be branched off from the first output line GOUT1. The phase input by an inverter IVT can be inverted. The inverter IVT can be a NOT gate. Therefore, since the second scan signal SC2 and the second-first scan signal SC2-1 can be output from one stage, an additional stage may not be required.

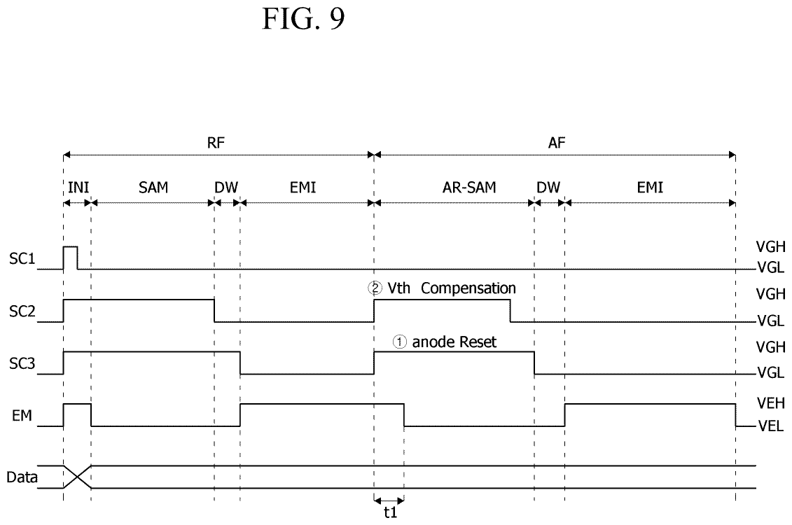

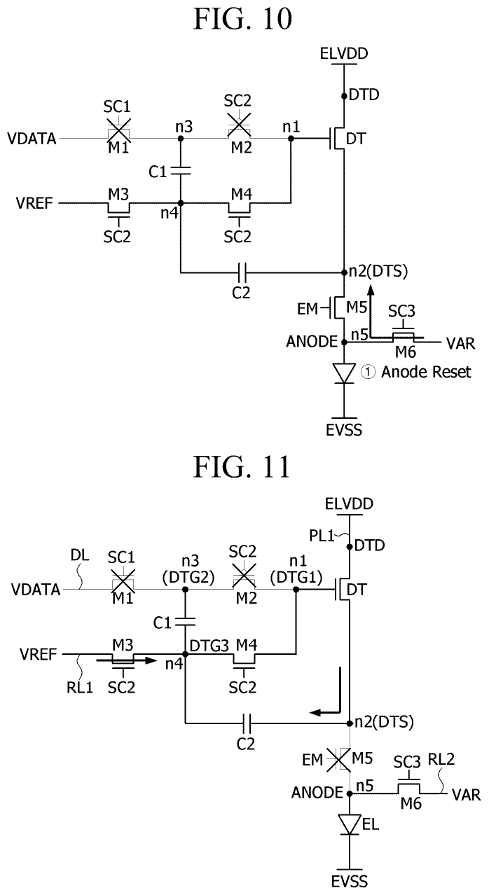

FIG. 9 is a waveform diagram showing a refresh frame and an anode reset frame operation of the pixel circuit in FIG. 5. FIG. 10 shows an anode reset operation of a pixel circuit according to one embodiment of the present disclosure. Referring to FIG. 11, a circuit diagram showing the operation of the pixel circuit during threshold voltage sensing.

Referring to FIG. 9, the pixel circuit can perform a refresh frame RF driving and an anode reset frame AF driving.

During the refresh frame RF driving, an initialization stage INI and a sampling stage SAM can be performed to write a data voltage to a sub-pixel SP during a non-emission period in which the emitting signal EM is applied at an off level.

During the anode reset frame AF driving, an anode reset stage AR-SAM, a data writing stage DW, and a light emission stage EMI can be performed. The data writing stage DW and the light emission stage EMI can be the same as in the refresh frame RF driving. According to the embodiment, the anode reset stage AR-SAM can perform both an anode reset and threshold voltage sampling.

Referring to FIGS. 9 and 10, in a first period t1 of the anode reset stage AR-SAM, the first scan signal SC1 and the EM signal EM can be applied with the gate low voltages VGL and VEL, and the second scan signal SC2 and the third scan signal SC3 can be applied with the gate high voltages VGH and VEH.

Accordingly, the first switching element M1 and the second switching element M2 can be turned off, and the third to sixth switching elements M3, M4, M5, and M6 can be turned on. Since the fifth switching element M5 and the sixth switching element M6 are turned on, the anode of the light-emitting element EL can be reset by a reset voltage VAR.

Referring to FIG. 11, after the first period t1 has elapsed, the EM signal can be turned off to allow the second node n2 to be floated. The anode reset stage can be maintained at the fifth node n5 by the sixth switching element M6. Thereafter, the threshold voltage Vth can be sensed, and the data voltage VDATA stored in the second node n2 can be applied to the gate electrode in the data writing stage DW.

In a low grayscale driving, the anode reset and the sampling can operate at a predetermined ratio. According to the embodiment, a benefit of low speed driving is that the anode reset and sampling can be performed multiple times during the anode reset frame section rather than in the refresh frame section.

The transistor is turned on in response to the gate-on voltage and is turned off in response to the gate-off voltage. In the case of the n-channel transistor, the gate-on voltage can be gate high voltages VGH and VEH, and the gate-off voltage can be gate low voltages VGL and VEH.

The present disclosure is not limited to the above. The present disclosure is not intended to be limited by the names of components or signals in the description of the embodiments of the present disclosure.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

[List of Reference Numbers]

| | |
|---|---|
| 110: Data driver | 120: Gate driver |
| 130: Timing controller | DT: Driving element |
| M1: First switching element | |

What is claimed is:

1. A pixel circuit comprising:
a driving element including a first electrode to which a pixel driving voltage is applied, a gate electrode connected to a first node, and a second electrode connected to a second node;
a first switching element configured to be turned on in response to a first scan signal to connect a data voltage line and a third node;
a second switching element configured to be turned on in response to a second scan signal to connect the third node and the first node;
a third switching element configured to be turned on in response to the second scan signal to connect a reference voltage line and a fourth node;
a fourth switching element configured to be turned on in response to the second scan signal to connect the fourth node and the first node;
a first capacitor connected between the third node and the fourth node; and
a second capacitor connected between the fourth node and the second node.

2. The pixel circuit of claim 1, further comprising:
a light-emitting element including an anode electrode connected to a fifth node and a cathode electrode to which a low potential power supply voltage is applied;
a fifth switching element configured to be turned on in response to an EM signal to connect the second node and the fifth node; and
a sixth switching element configured to be turned on in response to a third scan signal to connect the fifth node and a reset voltage line.

3. The pixel circuit of claim 2, wherein the first switching element and the third to sixth switching elements are n-type oxide transistors, and
the second switching element and the driving element are p-type polysilicon transistors.

4. The pixel circuit of claim 2, wherein the first to sixth switching elements are n-type oxide transistors.

5. The pixel circuit of claim 2, wherein the data voltage supplied to the data voltage line is higher than the reference voltage supplied to the reference voltage line, and
the reference voltage is higher than the reset voltage supplied to the reset voltage line.

6. The pixel circuit of claim 2, wherein the pixel circuit is configured to be driven in an order of an initialization stage, a sensing stage, a data writing stage, and a light emission stage.

7. The pixel circuit of claim 6, wherein in the initialization stage, the first switching element and the third to sixth switching elements are configured to be turned on and the second switching element is configured to be turned off, and
in the sensing stage, the third switching element, the fourth switching element, and the sixth switching element are configured to be turned on, and the first switching element, the second switching element, the fifth switching element are configured to be turned off.

8. The pixel circuit of claim 7, wherein in the data writing stage, the second switching element and the sixth switching element are configured to be turned on, and the first switching element, the third switching element, the fourth switching element, the fifth switching element are configured to be turned off, and
in the light emission stage, the second switching element and the fifth switching element are configured to be turned on, and the first switching element, the third switching element, the fourth switching element, and the sixth switching element are configured to be turned off.

9. The pixel circuit of claim 8, wherein in the initialization stage, the voltages of the first scan signal, the second scan signal, the third scan signal, and the EM signal are all gate high voltages,
in the sensing stage, the voltages of the first scan signal and the EM signal are gate low voltages, and the voltages of the second scan signal and the third scan signal are gate high voltages,
in the data writing stage, the voltages of the first scan signal, the second scan signal, and the EM signal are gate low voltages, and the voltage of the third scan signal is a gate high voltage, and
in the light emission stage, the voltages of the first to third scan signals are gate low voltages, and the voltage of the EM signal is a gate high voltage.

10. The pixel circuit of claim 7, wherein in the initialization stage, the first switching element is configured to be turned on to allow the data voltage to be stored in the first capacitor.

11. The pixel circuit of claim 7, wherein in the initialization stage, a reset voltage is applied to the fifth node to reset the anode electrode of the light-emitting element.

12. The pixel circuit of claim 7, wherein in the sensing stage, a threshold voltage of the driving element is stored in the second capacitor.

13. The pixel circuit of claim 8, wherein in the data writing stage, the second switching element is configured to be turned on to allow the data voltage stored in the third node to be applied to the first node.

14. The pixel circuit of claim 8, wherein in the light emission stage, the third switching element is configured to be turned off to allow the first capacitor and the second capacitor to be connected in series.

15. A display device comprising:
a display panel in which data lines, gate lines, power supply lines to which different constant voltages are applied, and sub-pixels are disposed;
a data driver configured to supply data voltages of pixel data to the data lines; and
a gate driver configured to supply scan signals and an EM signal to the gate lines,
wherein a pixel circuit of the sub-pixels includes:
a driving element including a first electrode to which a pixel driving voltage is applied, a gate electrode connected to a first node, and a second electrode connected to a second node;
a first switching element configured to be turned on in response to a first scan signal to connect a data voltage line and a third node;
a second switching element configured to be turned on in response to a second scan signal to connect the third node and the first node;
a third switching element configured to be turned on in response to the second scan signal to connect a reference voltage line and a fourth node;
a fourth switching element configured to be turned on in response to the second scan signal to connect the fourth node and the first node;
a first capacitor connected between the third node and the fourth node; and
a second capacitor connected between the fourth node and the second node.

16. The display device of claim 15, further comprising:
a light-emitting element including an anode electrode connected to a fifth node and a cathode electrode to which a low potential power supply voltage is applied;
a fifth switching element configured to be turned on in response to an EM signal to connect the second node and the fifth node; and
a sixth switching element configured to be turned on in response to a third scan signal to connect the fifth node and a reset voltage line.

17. The display device of claim 16, wherein the pixel circuit is driven in an order of an initialization stage, a sensing stage, a data writing stage, and a light emission stage.

18. The display device of claim 17, wherein in the initialization stage, the first switching element and the third to sixth switching elements are configured to be turned on, and the second switching element is configured to be turned off, and
in the sensing stage, the third switching element, the fourth switching element, and the sixth switching element are configured to be turned on, and the first switching element, the second switching element and the fifth switching element are configured to be turned off.

19. The display device of claim 17, wherein in the data writing stage, the second switching element and the sixth switching element are configured to be turned on, the first switching element, the third switching element, the fourth switching element and the fifth switching element are configured to be turned off, and
in the light emission stage, the second switching element and the fifth switching element are configured to be turned on, the first switching element, the third switching element, the fourth switching element and the sixth switching element are configured to be turned off.

20. The display device of claim 17, wherein in the initialization stage, the voltages of the first scan signal, the second scan signal, the third scan signal, and the EM signal are all gate high voltages,
in the sensing stage, the voltages of the first scan signal and the EM signal are gate low voltages, and the voltages of the second scan signal and the third scan signal are gate high voltages,
in the data writing stage, the voltages of the first scan signal, the second scan signal, and the EM signal are gate low voltages, and the voltage of the third scan signal is a gate high voltage, and
in the light emission stage, the voltages of the first to third scan signals are gate low voltages, and the voltage of the EM signal is a gate high voltage.
